(19) United States
(12) Patent Application Publication
(10) Pub. No.: US 2023/0418939 A1
(43) Pub. Date: Dec. 28, 2023

(54) METHOD FOR MANAGING EXTERNALLY IMPORTED FILES, APPARATUS FOR THE SAME, COMPUTER PROGRAM FOR THE SAME, AND RECORDING MEDIUM STORING COMPUTER PROGRAM THEREOF

(71) Applicant: Fasoo Co., Ltd, Seoul (KR)

(72) Inventors: Pil Gu KANG, Incheon (KR); Hyun Goo KANG, Incheon (KR); Ki Su SON, Seoul (KR); Dong Hyuk JANG, Gyeonggi-do (KR); Kyu Gon CHON, Gyeonggi-do (KR)

(21) Appl. No.: 18/339,177

(22) Filed: Jun. 21, 2023

(30) Foreign Application Priority Data
Jun. 22, 2022 (KR) 10-2022-0076221

(51) Int. Cl. G06F 21/56; H04L 67/06

(52) U.S. Cl. CPC G06F 21/565; H04L 67/06

(57) ABSTRACT

This application describes a method, a device, and a computer readable recording medium for managing an externally imported file. The method may be performed by determining that a created file is a monitoring target file based on a target extension and a target process of management policy information received from a management server, collecting file information of the file in response to the file being determined as the monitoring target file, determining whether the file is an externally imported file based on the file information and network traffic information, and recording import information in the file information in response to the file being determined as the externally imported file.

### CROSS-REFERENCE TO RELATED APPLICATIONS

This application claims the benefit of earlier filing date and right of priority to Korean Application No. 10-2022-0076221, filed on Jun. 22, 2022, the contents of which are all hereby incorporated by reference herein in their entirety.

### TECHNICAL FIELD

The present disclosure relates to a method, a device, a computer program and a recording medium for managing an externally imported file.

### BACKGROUND

An externally created file may be easily shared due to the development of Internet and cloud technology. In addition, since many files are shared in real time, the need to systematically manage them has emerged.

In addition, an externally imported file, unlike an internally created file, has a risk of containing virus or having incorrect information, so there is a need to manage it separately from an internally created file.

### BRIEF SUMMARY

In the past, files were managed by one file management method without distinguishing internally created files from externally imported files, so the present disclosure specifically discloses a method of managing files by efficiently distinguishing both files.

When an internally created file and an externally imported file are managed in the same way, there is a problem in which it is difficult to manage a path through which a file is imported, how it is shared in a company, etc.

In addition, if necessary, there is a problem in which it is difficult to destroy and limit the use of an externally imported file by distinguishing it from an internally created file.

In order to solve the problems, a method, a device, and a computer readable recording medium for managing an externally imported file according to an embodiment of the present disclosure may include a monitoring target determination step of determining whether a created file is a monitoring target file based on a target process and a target extension of management policy information received from a management server, a file information collection step of collecting file information of the file in response to the file being determined as the monitoring target file, an externally imported file determination step of determining whether the file is an externally imported file based on the file information and network traffic information; wherein, the network traffic information is input/output traffic information periodically collected from the target process, and an import information recording step of recording import information in the file information in response to the file being determined as the externally imported file.

In a method, a device, and a computer readable recording medium for managing an externally imported file according to an embodiment of the present disclosure, the monitoring target determination step may be performed in response to occurrence of an event that the file is created at a kernel level.

In a method, a device, and a computer readable recording medium for managing an externally imported file according to an embodiment of the present disclosure, the monitoring target determination step may be performed by determining that the file is the monitoring target file in response to a case in which a process of the file is the same as the target process and an extension of the file is the same as the target extension.

In a method, a device, and a computer readable recording medium for managing an externally imported file according to an embodiment of the present disclosure, the externally imported file determination step may be performed by determining that the file is the externally imported file in response to a case in which the file information is related to the network traffic information.

In a method, a device, and a computer readable recording medium for managing an externally imported file according to an embodiment of the present disclosure, a determination of the relevance may be performed by comparing a file size of the file information with a size of input/output data of the network traffic information at a time when the file is created.

In a method, a device, and a computer readable recording medium for managing an externally imported file according to an embodiment of the present disclosure, recording of the import information may be performed by changing pre-recorded last import information of the file information in response to a case in which there is pre-recorded import information in the file information, and recording of the import information may be performed by recording initial import information and last import information of the file information in response to a case in which there is no pre-recorded import information in the file information.

In a method, a device, and a computer readable recording medium for managing an externally imported file according to an embodiment of the present disclosure, the recorded import information and detection information received from the management server may be used to detect an externally imported file among files input/output in real time, the detected externally imported file may be processed based on processing rule information received from the management server and the processing may be any one of classification, deletion or encryption.

In a method, a device, and a computer readable recording medium for managing an externally imported file according to an embodiment of the present disclosure, the recorded import information may be maintained as it is although the file is copied or moved to other terminal or server.

A method, a device, and a computer readable recording medium for managing an externally imported file of the present disclosure has an effect of efficiently distinguishing between an internally created file and an externally imported file by recording import information of a file created in real time.

In addition, it has an effect of performing and managing a function such as classification, deletion, encryption, etc. by distinguishing between an internally created file and an externally imported file using the recorded import information.

### DESCRIPTION OF DRAWINGS

FIG. 1 is a diagram which represents a configuration of a device which manages an externally imported file according to an embodiment of the present disclosure.

FIG. 2 is a flowchart for a method of managing an externally imported file according to an embodiment of the present disclosure.

FIG. 3 is a flowchart for a method of processing an externally imported file in a file inspection unit according to an embodiment of the present disclosure.

### DETAILED DESCRIPTION

Hereinafter, embodiments of the present invention will be described in detail so that those skilled in the art can easily carry out the present invention referring to the accompanying drawings. However, the present disclosure may be embodied in many different forms and is not limited to the embodiments described herein.

In the following description of the embodiments of the present invention, a detailed description of known functions and configurations incorporated herein will be omitted when it may make the subject matter of the present disclosure unclear. Parts not related to the description of the present disclosure in the drawings are omitted, and similar parts are denoted by similar reference numerals.

In the present disclosure, when an element is referred to as being “connected”, “coupled”, or “accessed” to another element, it is understood to include not only a direct connection relationship but also an indirect connection relationship. Also, when an element is referred to as “containing” or “having” another element, it means not only excluding another element but also further including another element.

In the present disclosure, the terms “first”, “second”, and so on are used only for the purpose of distinguishing one element from another, and do not limit the order or importance of the elements unless specifically mentioned. Thus, within the scope of this disclosure, the first component in one embodiment may be referred to as a second component in another embodiment, and similarly a second component in one embodiment may be referred to as a second component in another embodiment.

In the present disclosure, components that are distinguished from one another are intended to clearly illustrate each feature and do not necessarily mean that components are separate. That is, a plurality of components may be integrated into one hardware or software unit, or a single component may be distributed into a plurality of hardware or software units. Accordingly, such integrated or distributed embodiments are also included within the scope of the present disclosure, unless otherwise noted.

In the present disclosure, the components described in the various embodiments do not necessarily mean essential components, but some may be optional components. Accordingly, embodiments consisting of a subset of the components described in one embodiment are also included within the scope of this disclosure. Also, embodiments that include other components in addition to the components described in the various embodiments are also included in the scope of the present disclosure.

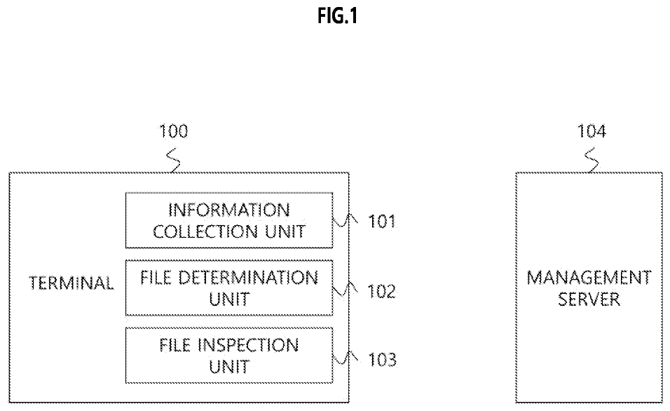

FIG. 1 is a diagram which represents a configuration of a device which manages an externally imported file according to an embodiment of the present disclosure.

A terminal 100 may include at least one of an information collection unit 101, a file determination unit 102 or a file inspection unit 103.

A terminal 100 may transmit/receive management policy information with a management server 104.

A management server 104 may transmit/receive information such as management policy information, information on a file status, etc. through at least one terminal or other server and network. In FIG. 1, it was shown that a management server 104 is included in a device distinguished from a terminal, but it is not limited thereto, and in some cases, a management server may be included in a specific terminal.

A management server 104 may configure management policy information.

Here, management policy information may include at least one of external import policy information related to whether a created file is a monitoring target or inspection policy information related to detection and processing of an externally imported file.

Accordingly, a configuration of management policy information may include at least one of a configuration of external import policy information or a configuration of inspection policy information.

External import policy information may include a (monitoring) target process and a target extension which are a standard for determining whether a created file is a monitoring target. Accordingly, whether a created file is a monitoring target may be determined based on the target process and the target extension. The determination is performed in an information collection unit 101, so detailed contents are described later.

Inspection policy information may include at least one of detection information used to detect an externally imported file through inspection or processing rule information used to process a detected file.

Accordingly, a configuration of inspection policy information may include at least one of a configuration of detection information or a configuration of processing rule information.

Detection information may include a file inspection time, information used to detect an externally imported file, and a method of detecting an externally imported file.

Here, a file inspection time may include at least one of a periodic time of inspecting a file periodically or a specific (aperiodic) time of inspecting a file when a specific event occurs.

Here, a specific event may include a file In/Out event and a file creation event.

Creation of a file in a file creation event may include changing file information of a file or creating a new file by a function such as Copy/Export/Save/Save as, etc. of a file.

File information may include basic attribute information and additional attribute information of a file.

As basic attribute information of a file is attribute information stored in a file itself, it may include a name of a file, a format (or an extension) of a file, a process of a file, a storage location of a file, a size of a file, a disk allocation size of a file, a creation date of a file, a modification date of a file, an access date of a file, identification information identifying a device (a terminal or a server) in which a file is stored, a user authority of a file, and security information.

As additional attribute information of a file is additional attribute information stored in a file itself or a database connected to a file, it may include monitoring target file identifier information for whether a file is a monitoring target file, externally imported file identifier information indicating whether a file is an externally imported file, file I/O (In/Out) packet information, and network information of a file. Here, network information of a file may include first/last import information of a file, intermediate import information of a file, and network identification information used for file transmission/reception.

Monitoring target file identifier information may represent that a corresponding file is a monitoring target file when a monitoring target file identifier has a first value and may represent that a corresponding file is not a monitoring target file when a monitoring target file identifier has a second value.

Externally imported file identifier information may represent that a corresponding file is an externally imported file when an externally imported file identifier has a first value and may represent that a corresponding file is not an externally imported file when an externally imported file identifier has a second value.

A management server 104 may manage a file status database.

A file status database may be a database that files of at least one of a management server 104, a terminal connected to a management server or other server connected to a management server are organized based on a priority of file information. Here, file information may include at least one of basic attribute information or additional attribute information of a file, and a description therefor is described above, so it is omitted.

In an example, basic attribute information of a file may be stored in a file itself, and additional attribute information of a file and part of basic attribute information of a file which are key data of the database may be stored in a file status database.

Data in a file status database may be divided and organized according to a priority of file information. In an example, when identification information identifying a device (a terminal or a server) in which a file is stored is a first priority, data of a file status database may be divided and organized per device (terminal or server). In an example, when externally imported file identifier information representing whether a file is an externally imported file is a first priority, regardless of a device (a terminal or a server), data of a file status database may be divided and organized according to whether files are an externally imported file.

The priority may be a priority which is pre-fixed in a terminal or a management server or a priority which is configured or changed at the request of a terminal or a management server or at the request of a user.

A combination of identification information identifying a device (a terminal or a server) in which a file of basic attribute information of a file is stored, a storage location of a file, a name of a file and an extension of a file may be used as key data used to inquiry into file status database. For example, when an identification number of a terminal where a file is stored is ‘N0001’, a storage location of a file is ‘C\Windows\’, a name of a file is ‘test’ and an extension of a file is ‘*.pdf’, ‘N0001\C\Windows\test.pdf’, a combination thereof, may be utilized as key data of a file of a file status database. Here, key data of a file may represent data that a corresponding file and data of a file status database are connected.

An information collection unit 101 may receive management policy information from a management server 104.

Here, management policy information may include at least one of external import policy information related to whether a created file is a monitoring target or inspection policy information related to detection and processing of an externally imported file.

Creation of a file may include changing file information of a file or creating a new file by a function such as Copy/Export/Save/Save as, etc. of a file.

File information may include basic attribute information and additional attribute information of a file.

As basic attribute information of a file is attribute information stored in a file itself, it may include a name of a file, a format (or an extension) of a file, a process of a file, a storage location of a file, a size of a file, a disk allocation size of a file, a creation date of a file, a modification date of a file, an access date of a file, identification information identifying a device (a terminal or a server) in which a file is stored, a user authority of a file, and security information.

As additional attribute information of a file is additional attribute information stored in a file itself or a database connected to a file, it may include monitoring target file identifier information for whether a file is a monitoring target file, externally imported file identifier information indicating whether a file is an externally imported file, file I/O (In/Out) packet information, and network information of a file. Here, network information of a file may include first/last import information of a file, intermediate import information of a file, and network identification information used for file transmission/reception.

External import policy information may include a (monitoring) target process and a target extension which are a standard for determining whether a created file is a monitoring target. In other words, whether a created file is a monitoring target may be determined based on the target process and the target extension.

An information collection unit 101 may determine whether a file is a monitoring target file periodically or when a specific event occurs based on management policy information.

Here, a specific event may include an event which occurs at a kernel level. In addition, the specific event includes an event of file creation that a file is created and creation of a file is described above, so it is omitted.

In an example, when an event occurs in which a file is created at a kernel level, an information collection unit 101 may determine that a created file is a monitoring target file when a process of a created file matches a target process of external import policy information and an extension of the created file is the same as a target extension of external import policy information.

In an example, when external import policy information configures a target process as ‘Chrome.exe’ and a target extension as ‘*.pdf’, an information collection unit 101 may determine that a PDF file downloaded through Chrome browser is a monitoring target file.

An information collection unit 101 may collect file information of a file which is determined as a monitoring target file based on management policy information.

File information may include basic attribute information and additional attribute information of a file. It is described above, so it is omitted.

As basic attribute information of a file is attribute information stored in a file itself, it may include a name of a file, a format (or an extension) of a file, a process of a file, a storage location of a file, a size of a file, a disk allocation size of a file, a creation date of a file, a modification date of a file, an access date of a file, identification information identifying a device (a terminal or a server) in which a file is stored, a user authority of a file, and security information.

As additional attribute information of a file is additional attribute information stored in a file itself or a database connected to a file, it may include monitoring target file identifier information for whether a file is a monitoring target file, externally imported file identifier information indicating whether a file is an externally imported file, file I/O (In/Out) packet information, and network information of a file. Here, network information of a file may include first/last import information of a file, intermediate import information of a file, and network identification information used for file transmission/reception.

As an embodiment, when an event occurs in which a file is created at a kernel level, an information collection unit 101 may determine whether it is a monitoring target file based on a target process and a target extension of external import policy information. In addition, when a created file is determined as a monitoring target file, an information collection unit 101 may collect file information of a corresponding file. Here, a determination on whether it is a monitoring target file may be performed based on whether a process of a created file matches a target process of external import policy information and an extension of the created file is the same as a target extension of external import policy information.

An information collection unit 101 may store collected file information of a monitoring target file in a file itself stored in a memory. Alternatively, an information collection unit 101 may store basic attribute information of a file among collected file information of a monitoring target file in a file itself stored in a memory and transmit additional attribute information of a file and part of basic attribute information of a file which are key data of a file status database to be stored in a database of a terminal itself or to be stored in a database of a management server 104.

In addition, an information collection unit 101 may transmit collected file information of a monitoring target file to a file determination unit 102.

An information collection unit 101 may collect network traffic information periodically or when a specific event occurs based on management policy information.

Here, a specific event may include an event which occurs at a kernel level. In addition, the specific event may include an event of file creation that a file is created, an event that a file is determined as a monitoring target file, and an event that IN/OUT of a file occurs on a network. Creation of a file is described above, so a specific description is omitted.

Here, network traffic information may include a size, time, an IP, and a process of IN/OUT data.

In an example, an information collection unit 101 may periodically collect IN/OUT traffic information occurred in a target process of external import policy information in a Transmission Control Protocol (TCP) table. In this case, when a target process is ‘chrome.exe’, IN/OUT traffic information may be IN/OUT traffic information which is generated in the chrome browser and periodically collected.

In an example, when a created file is determined as a monitoring target file, an information collection unit 101 may collect network traffic information based on a time of file creation. In this case, when a target process is ‘chrome.exe’, IN/OUT traffic information may be IN/OUT traffic information which is generated in the chrome browser. In addition, when a file creation event is to download a file in the chrome browser, an information collection unit 101 may collect IN/OUT traffic information generated in the Chrome browser from the start of file download to the end.

An information collection unit 101 may store collected network traffic information in a file itself stored in a memory. Alternatively, an information collection unit 101 may store collected network traffic information in a database of a terminal itself or transmit it to be stored in a database of a management server 104.

In addition, an information collection unit 101 may transmit collected network traffic information to a file determination unit 102.

A process of collecting at least one of file information or network traffic information in an information collection unit 101 may be performed by a driver module operating at a kernel level.

A file determination unit 102 may determine validity of at least one of network traffic information or file information of a monitoring target file acquired from an information collection unit 101.

When it is determined that the file information and the network traffic information are valid, a file determination unit 102 may determine whether a created monitoring target file is an externally imported file which is imported externally based on the file information and the network traffic information.

Specifically, a determination on whether it is an externally imported file may be performed by analyzing a correlation between file information of a created monitoring target file and network traffic information at a time when the file is created, determining whether a created monitoring target file is created through a network based on the correlation and determining the file as an externally imported file if it is determined that the file is created through a network.

In an example, the correlation analysis may be performed by comparing a size of a file among file information of a created monitoring target file with a size of IN/OUT data at a time of file creation. Here, when a file is created by being downloaded through a browser, a size of IN/OUT data at a time of file creation may represent a size of data IN/OUT through a network from the start of download to the end of download.

In addition, as in a case when a file in a size similar to a corresponding file is downloaded simultaneously at a file creation time of a corresponding file, when it is difficult to analyze a correlation only by comparing a file size with a data size, other information of file information and network information (e.g., file I/O packet information, an IP of a network) may be additionally referred to.

When it is determined that a created monitoring target file is an externally imported file, a file determination unit 102 may record or renew file information of the file.

In an example, the recorded or renewed file information may be externally imported file identifier information representing whether a file of additional attribute information of a file is an externally imported file. Specifically, when an externally imported file identifier of externally imported file identifier information has no value (has a Null value) or has a second value representing that a corresponding file is not an externally imported file as a default value, an externally imported file identifier value may be recorded or renewed as a first value representing that a corresponding is an externally imported file.

In an example, the recorded or renewed file information may be import information of network information of a file. In this case, when there is no pre-recorded import information in a file, based on network traffic information related to an externally imported file, first import information and last import information of an externally imported file may be recorded. On the contrary, when there is pre-recorded import information in a file, based on network traffic information related to an externally imported file, last import information of an externally imported file may be renewed.

Import information of file information may be maintained as it is even though a corresponding file is copied or moved to other terminal or server. Through it, an externally imported file may be easily detected and managed in other terminal.

A file determination unit 102, when file information is recorded or renewed, may request to record or renew file information of other terminal or server connected to the file information in the same way as the recorded or renewed file information.

A file inspection unit 103 may inspect files to detect an externally imported file of files based on inspection policy information and process the detected externally imported file.

A file inspection unit may receive inspection policy information from a management server 104.

Inspection policy information may include at least one of detection information used to detect an externally imported file through inspection or processing rule information used to process a detected file.

Detection information may include a file inspection time, information used to detect an externally imported file, and a method of detecting an externally imported file.

Here, a file inspection time may include at least one of a periodic time of inspecting a file periodically or a specific (aperiodic) time of inspecting a file when a specific event occurs.

Here, a specific event may include a file creation event that a file is created, an event that a file is IN/OUT, and an event that import information of a file is recorded or renewed. A description on file creation is described above, so it is omitted.

A file inspection unit 103 may detect an externally imported file based on file information and detection information of inspection policy information.

In an example, when a file is IN/OUT in real-time, a file inspection unit 103 may detect an externally imported file by inspecting a corresponding file through a method of detecting an externally imported file.

Detection of an externally imported file may be performed by confirming externally imported file identifier information representing whether a file among file information is an externally imported file.

Specifically, when an externally imported file identifier of the externally imported file identifier information has no value (has a null value) or has a second value representing that the file is not an externally imported file, the file is not an externally imported file, so the file may not be detected as an externally imported file. On the contrary, when an externally imported file identifier of the externally imported file identifier information has a first value representing that the file is an externally imported file, the file is an externally imported file, so the file may be detected as an externally imported file.

Alternatively, detection of an externally imported file may be performed by confirming import information of file information.

Specifically, when file information of a file has pre-recorded import information, the file may be detected as an externally imported file. For example, when at least one of first import information or last import information is entered in file information, a target file of the file information may be detected as an externally imported file. On the contrary, when file information of a file has no pre-recorded import information (or has a null value or a default value), the file may not be detected as an externally imported file.

In an example, when a file is copied in other terminal, a file inspection unit 103 may detect the file as an externally imported file if file information of the file has pre-recorded import information or an externally imported file identifier of the file information represents that the file is an externally imported file.

A file inspection unit 103 may transmit detection information of the externally imported file to a management server 104 when an externally imported file is detected. Here, detection information may be used to renew data of a file status database and a management server 104 may manage an externally imported file status in an integrated way through the renewed database.

A file inspection unit 103 may process a detected externally imported file based on processing rule information of inspection policy information. Here, processing may include performing classification, deletion and encryption.

When a detected externally imported file is processed, a file inspection unit 103 may transmit processing information of the externally imported file to a management server 104. Here, processing information may be used to renew data of a file status database and a management server 104 may manage an externally imported file status in an integrated way through the renewed database. In an example, when an externally imported file is deleted, based on processing information (deletion information) transmitted from a file inspection unit 103, a management server 104 may delete data of a database of a management server connected to the file.

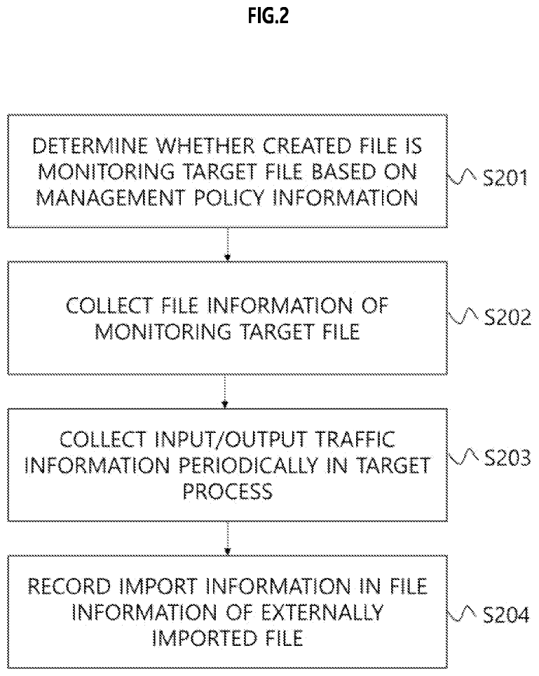

FIG. 2 is a flowchart for a method of managing an externally imported file according to an embodiment of the present disclosure.

A method of managing an externally imported file may include at least one of a monitoring target determination step S201 of determining whether a created file is a monitoring target file based on a target extension and a target process of management policy information received from a management server, a file information collection step S202 of collecting file information of the file in response to the file being determined as the monitoring target file, a network traffic information collection step S203 of collecting input/output traffic information periodically from the target process, or an import information recording step S204 of recording import information in the file information in response to the file being determined as the externally imported file. Specific contents for each step are the same as the above-described description in a device, so there are omitted.

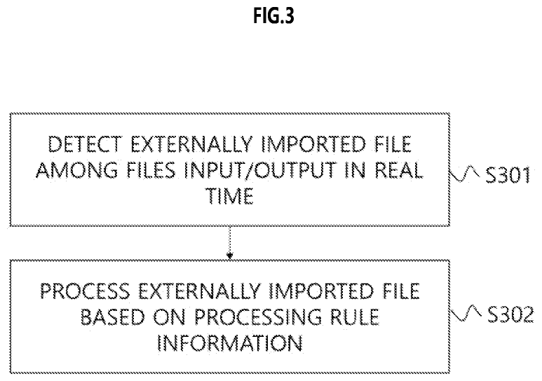

FIG. 3 is a flowchart for a method of processing an externally imported file in a file inspection unit according to an embodiment of the present disclosure.

Based on recorded import information and detection information received from a management server, at least one of an externally imported file detection step S301 of detecting an externally imported file among files IN/OUT in real-time, or a processing step S302 of processing the detected externally imported file based on processing rule information received from the management server may be included. Specific contents for each step are the same as the above-described description in a device, so there are omitted.

A method of creating test data according to an embodiment of the present disclosure may be implemented by a computer readable recording medium including a program instruction for performing a variety of operations implemented by a computer. The computer readable recording medium may include a program instruction, a local data file, a local data structure, etc. alone or in combination. The recording medium may be specially designed and configured for an embodiment of the present disclosure or may be used by being notified to those skilled in computer software. An example of a computer readable recording medium includes magnetic media such as a hard disk, a floppy disk and a magnetic tape, optical recording media such as a CD-ROM, a DVD, etc., magneto-optical media such as a floptical disk, and a hardware device which is specially configured to store and perform a program instruction such as ROM, RAM, a flash memory, etc. The recording medium may be a transmission medium such as an optical or metallic line, a wave guide, etc. including a carrier transmitting a signal designating a program instruction, a local data structure, etc. An example of a program instruction may include a high-level language code which may be executed by a computer using an interpreter, etc. as well as a machine language code generated by a compiler.

As a description above is just an illustrative description for a technical idea of the present disclosure, it may be changed and modified in various ways by those with ordinary skill in the art to which the present disclosure pertains within a scope not departing from an essential characteristic of the present disclosure. In addition, embodiments disclosed in the present disclosure are intended not to limit, but to explain a technical idea of the present disclosure, and a scope of a technical idea of the present disclosure is not limited by these embodiments. Accordingly, a protection scope of the present disclosure should be interpreted by claims below, and all technical ideas within a scope equivalent thereto should be interpreted as being included in a scope of a right of the present disclosure.

1. A method of managing an externally imported file, the method comprising:
a monitoring target determination step of determining whether a created file is a monitoring target file based on a target process and a target extension of management policy information received from a management server;
a file information collection step of collecting file information of the file in response to the file being determined as the monitoring target file;
an externally imported file determination step of determining whether the file is the externally imported file based on the file information and network traffic information, wherein the network traffic information is input/output traffic information periodically collected from the target process; and
an import information recording step of recording import information in the file information in response to the file being determined as the externally imported file.

2. The method of claim 1, wherein:
the monitoring target determination step is performed in response to occurrence of an event that the file is created at a kernel level.

3. The method of claim 2, wherein:
the monitoring target determination step is performed by determining that the file is the monitoring target file in response to a case in which a process of the file is the same as the target process and an extension of the file is the same as the target extension.

4. The method of claim 3, wherein:
the externally imported file determination step is performed by determining that the file is the externally imported file in response to the case in which the file information is related to the network traffic information.

5. The method of claim 4, wherein:
a determination of the relevance is performed by comparing a file size of the file information with a size of input/output data of the network traffic information at a time when the file is created.

6. The method of claim 1, wherein:
recording of the import information is performed by changing pre-recorded last import information of the file information in response to a case in which there is pre-recorded import information in the file information,
recording of the import information is performed by recording initial import information and last import information of the file information in response to the case in which there is no pre-recorded import information in the file information.

7. The method of claim 1, wherein:
the recorded import information and detection information received from the management server is used to detect the externally imported file among files input/output in real time,
the detected externally imported file is processed based on processing rule information received from the management server,
the processing is any one of classification, deletion or encryption.

8. The method of claim 1, wherein:
the recorded import information is maintained as it is although the file is copied or moved to other terminal or server.

9. A device of managing an externally imported file, the device comprising:
an information collection unit of:
determining whether a created file is a monitoring target file based on a target extension and a target process of management policy information received from a management server, and
collecting file information of the file in response to the file being determined as the monitoring target file; and
a file determination unit of:
determining whether the file is the externally imported file based on the file information and network traffic information, wherein the network traffic information is input/output traffic information collected periodically from the target process, and
recording import information in the file information in response to the file being determined as the monitoring target file.

10. A non-transitory computer readable recording medium, wherein:
a computer program for executing a method according to claim 1 in a computer is recorded.
